(19) United States
(12) Patent Application Publication
(10) Pub. No.: US 2007/0198552 A1
(43) Pub. Date: Aug. 23, 2007

(54) System, method, and programs for automatically building audit triggers on database tables

(76) Inventor: Phil Farrand, Fair Grove, MO (US)

Correspondence Address: Phil Farrand, 9048 N. Country Manor Lane, Fair Grove, MO, 65648, US

(21) Appl. No.: 11/705,472

(22) Filed: Feb. 12, 2007

Related U.S. Application Data
(60) Provisional application No. 60/773,174, filed on Feb. 14, 2006.

(51) Int. Cl. G06F 7/00

(52) U.S. Cl. 707/100

(57) ABSTRACT

A method and system for building audit triggers on database tables is presented. The method includes compiling at least one informational table containing names of one or more source tables to be audited, constructing at least one build trigger having sufficient functionality for building audit triggers on the source tables, and installing the informational table and build trigger in a database environment in which the build trigger instructs a database engine to build audit triggers on the source tables.

### CROSS-REFERENCE TO RELATED APPLICATIONS

The present Utility patent application claims priority benefit of the [U.S. provisional application for patent Ser. No. 60/773,174 entitled “System and method for automatically building audit triggers on database tables” and filed on Feb. 14, 2006 under 35 U.S.C. 119(e). The contents of this related provisional application are incorporated herein by reference for all purposes.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to databases. More particularly, the invention relates to a system and method of recording changes made to data in databases.

### BACKGROUND OF THE INVENTION

The process of recording changes to data in a database is known as auditing. The auditing process can take many different forms and be accomplished in many different ways. For instance, without limitation, creating an audit trail of data changes data can be as simple as adding a column to a table called “CreationDate” and adding a default to that column for the current data and time. When a new record is created, the current date and time is stored in the column. At any later date, the creation date of the record can be reviewed to determine when the record was created. Other similar columns can be created to audit data. Most commonly, these columns include, without limitation, the name of the user who created the record, the last modification date of the record and the name of the user who last modified the record.

Another approach to auditing data involves manually coding a statement to make copies of any data that is about to change in the database just prior to actually changing the data.

Another approach to auditing data involves manually coding a database table trigger. Database triggers execute every time data is changed in the table. When the manually coded trigger executes, the trigger writes the data that has changed into an audit table. Both the audit table and the trigger are manually maintained.

Another approach to auditing data involves the use of an application to create the triggers in a more automated fashion. However, this process is essentially the same as the process involving a manual trigger.

Another approach to auditing data involves the use of a transaction log viewer. Transaction logs are created by database engines to assist with backup recovery. Typically when a database restore is requested, the database administrator first restores the last full backup of the database and then incrementally applies the transaction log backups until the desired time of restoration is accomplished. Since these transaction logs track the changes to data, the transaction logs can additionally be used for audit purposes provided the user has access to a transaction log viewer.

Each of these approaches has certain limitations and/or disadvantages. For example, without limitation, the use of creation and modification columns only records the time when the insert or update operation is performed and does not record the actual data that was involved. In addition, the use of a “modified by” and/or “modification date” column only records the last time the data was modified, not the entire chain of modifications.

Manually coded statements are tedious to write and must be written for every instance of data manipulation. Also, while manually coded triggers can certainly record every modification to the data, any changes to the number and/or type of columns in the table must be manually included, raising the possibility of error and neglect.

The use of an application to generate audit triggers reduces the potential for error and provides a great deal of flexibility in designing the trigger. However, since the trigger is being designed by an entity that exists outside the environment of the database, the applications's potential for external automation is limited. For example, without limitation, it is very difficult to launch an application from within a stored procedure and remotely instruct the application to alter a given audit trigger according to some preconceived scheme.

And finally, while transaction log viewers never need updating due to changes in the number and type of columns in a table, transaction log viewers are merely reporting on data that was created solely for backup recovery and is therefore limited in its ability to provide selective auditing of data changes within a specific set of criteria. For instance, without limitation a given business might only desire to audit and retain performance data on employees who are on probation. In other words, at the moment that the performance record is created, the auditing functionality must be able to determine if the employee connected to the performance record is on probation. Transaction logs are not concerned with these kinds of connections. Transaction logs merely record changes to data, and therefore the transaction log viewer is limited in scope.

In view of the foregoing, there is a need for an improved method of auditing a database that is able to record the change in the data and the entire chain of data modifications, is not prone to errors, that is not outside the environment of the database, and is not limited in scope.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flowchart illustrating the steps involved in an exemplary process of creating and executing a build trigger that exists on a sole informational table, in accordance with an embodiment of the present invention;

FIG. 2 is a flowchart illustrating an exemplary process of constructing and executing an audit trigger comprising a designations table to hold source table names and a rules table to hold rules that dictate how the trigger is constructed, in accordance with an embodiment of the present invention;

FIGS. 3 through 6 illustrate an exemplary system for automatically building audit triggers on a database, in accordance with an embodiment of the present invention. FIG. 3 shows an exemplary process that occurs when a programmer alters information in either the designations table or the rules table and causes one or more audit triggers to be built on the source tables of the audit operation. FIG. 4 shows an exemplary process that occurs when a user alters data in an audited table that contains an audit trigger built by the process shown by way of example in FIG. 3. FIG. 5 shows an exemplary process that occurs when a programmer alters the information in either the designations table or the rules table and causes the maintenance procedure to be built or rebuilt; and

FIG. 6 shows an exemplary process that occurs when a maintenance procedure is scheduled that archives audit data, discards audit data or both.

Unless otherwise indicated illustrations in the figures are not necessarily drawn to scale.

### SUMMARY OF THE INVENTION

To achieve the forgoing and other objects and in accordance with the purpose of the invention, a method and a system for building audit triggers on database tables is presented.

In one embodiment, a method for building audit triggers on database tables is presented. The method includes compiling at least one information table having names of one or more source tables to be audited, constructing at least one build trigger having sufficient functionality for building audit triggers on the source tables, and installing the informational table and build trigger in a database environment in which the build trigger instructs a database engine to build audit triggers on the source tables.

In another embodiment, a method for building audit triggers on database tables is presented. The method includes the steps for providing at least one informational table, constructing at least one build trigger, and installing the informational table and the build trigger in a database environment in which the build trigger instructs a database engine to construct the audit triggers.

In another embodiment, a system for building and using audit triggers on database tables is presented. The system includes a means for constructing at least one informational table, a means for constructing a build trigger, a means for installing the informational table and the build trigger in a database environment where audit triggers are constructed, and a means for accessing the database tables and activating audit triggers.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognized a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternatives embodiments do not necessarily imply that the two are mutually exclusive.

The present invention will now be described in detail with reference to embodiments thereof as illustrated in the accompanying drawings.

The preferred embodiment of the present invention functions in the environment of a database. The preferred embodiment requires at least one informational table that hold the names of tables to be audited and a trigger that can build the audit triggers. Additionally, the preferred embodiment may include, without limitation, one or more other informational tables that provide guidance to the functionality that actually builds audit triggers.

The preferred embodiment of the present invention comprises one or more tables in a database that hold information about the tables to be audited and the types of auditing to be employed. These informative tables include, without limitation, triggers that have sufficient functionality to automatically build audit triggers on the tables that should be audited, for example, without limitation, “source” tables, whenever the informative data changes. Other components of the preferred embodiment include, but are not limited to, audit data tables, archive audit data tables, maintenance procedures for archiving and deleting audit data, a log table and a utility to retrieve the names and data types of the columns in a specific table. The preferred embodiment provides audit triggers on any desired table within seconds of installing the system, which, preferably, takes only seconds itself. The preferred embodiment also has a great deal of flexibility over how audit triggers are built at both a global level and a specific level.

Embodiments of the present invention generate audit data. This audit data is a record of changes to data both at a record-level, for example, without limitation, this record was changed on this data, and at a column-level, for example, without limitation, the value in column A changed from “1” to “2”. The preferred embodiment is powered by a database engine. In order to make use of embodiments of the present invention, a database should provide trigger functionality.

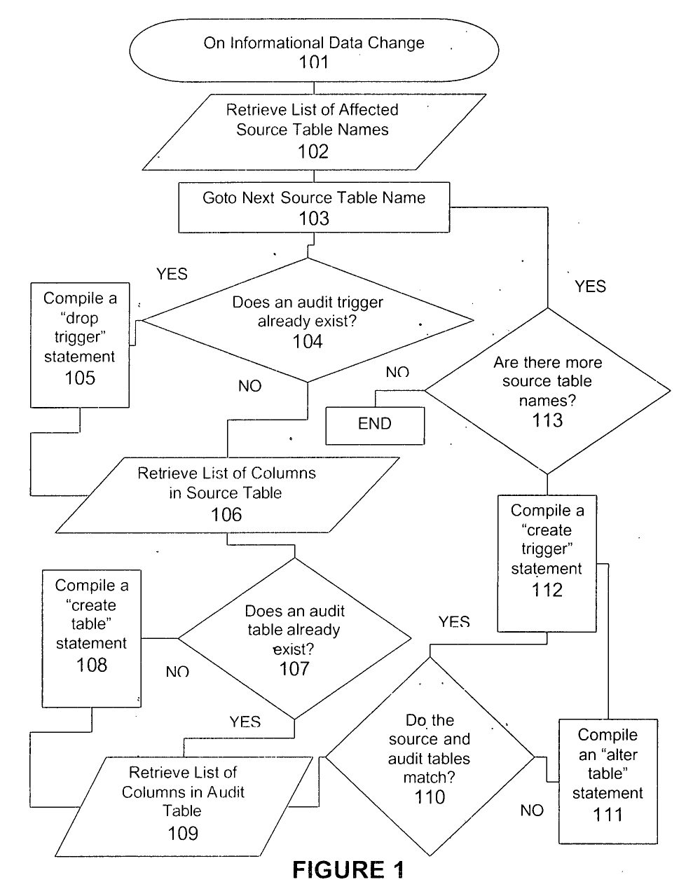

FIG. 1 is a flowchart illustrating the steps involved in an exemplary process of creating and executing a build trigger that exists on a sole informational table, in accordance with an embodiment of the present invention. When there is a change to the data in the information table, step 101, the build trigger retrieves a list of all of the source table names in the informational table that have changed in step 102. Then in step 103, the process goes to the next source table name from the list of source table names compiled in step 102. For each source table name, the process tests to see if an audit trigger already exists on the source table in step 104. If an audit trigger exists, the process compiles a drop trigger statement and executes this drop trigger statement in step 105. In the present embodiment, the drop trigger statement is a single line of code executed by the database engine that deletes the existing trigger. The process then continues by retrieving a list of columns that exist on the source table in step 106. If at step 104 an audit trigger does not exist, the process proceeds directly to step 106.

Then, in step 107, the process tests for the existence of an audit table. If an audit table does not exist, the process compiles and executes a create table statement in step 108. With the audit table in place, the process retrieves a list of the columns on the audit table in step 109. If an audit table exists in step 107, the process proceeds directly to step 109. Then the process tests to see if the list of the columns on the source table matches the list of the columns on the audit table in step 110. If the list of columns does not match, the process compiles an alter table statement in step 111. The alter table statement alters the number of type of columns in the audit table so that the number and type of columns matches the number and type of columns in the source table. Once the columns match, the process compiles a create trigger statement on the source table in step 112 so that any change in data on the source table will cause the trigger to execute and move a copy of the changed data from the source table to the audit table. If in step 110 the source table and the list of columns on the audit table match, the process proceeds directly to step 112. The process then determines in step 113 if there are source table names remaining on the source table name list compiled in step 102. If there are source table names remaining, the process returns to step 103 to go to the next source table name in the source table name list and the entire process is repeated. If there are no more source table names remaining on the source table name list, the process ends.

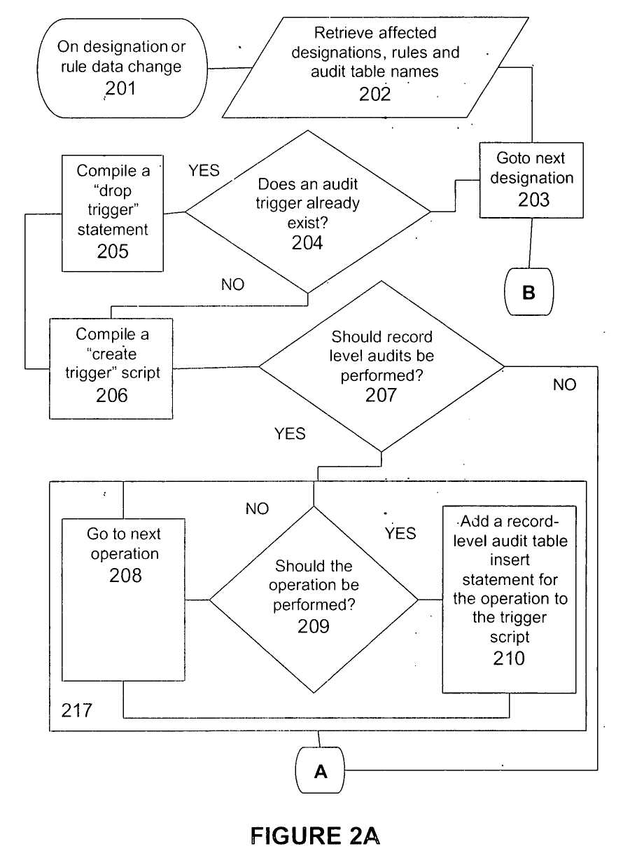

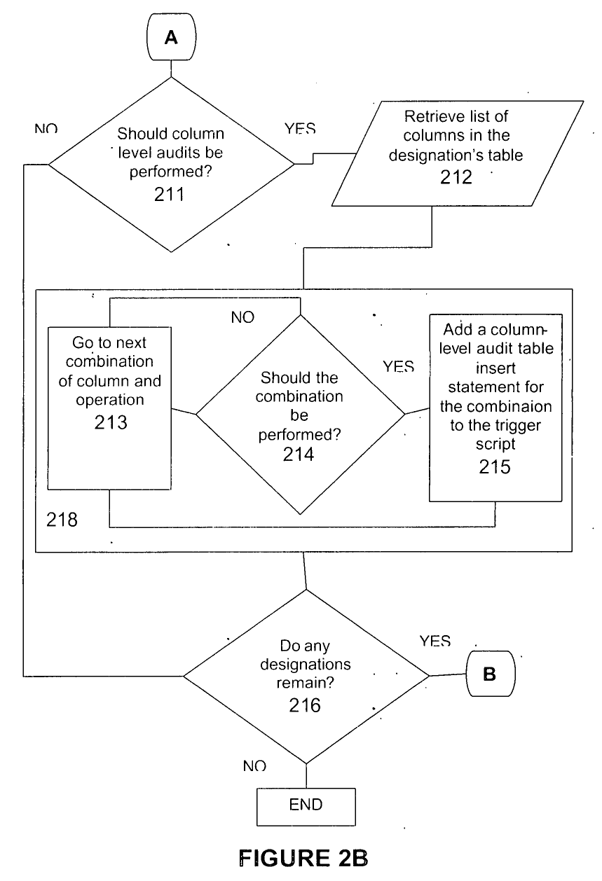

FIG. 2 is a flowchart illustrating an exemplary process of constructing and executing an audit trigger comprising a designations table to hold source table names and a rules table to hold rules that dictate how the trigger is constructed, in accordance with an embodiment of the present invention. The term designation refers to aliases assigned to table names. For instance, without limitation, a table named Orders might be given a designation of Order. Throughout the system in the present example, the Orders table is referred to as Order. This becomes useful when auditing data from multiple databases on a server because the fully qualified table name, for example, without limitation, MyDatabaseName.My.Schema.Orders, is entered only in the designations table and from then on may be identified simply by Order.

When there is a change in the designations or the rules table, step 201, all of the necessary information about trigger construction, such as, but not limited to designation table names, rules tables names, and audit table names, is gathered in step 202. In step 203, the process then goes to the next designation tale name as gathered in step 202. For each affected designation, the process tests to see if an audit trigger exists in step 204. If an audit trigger exists, a statement to drop the trigger is compiled and executed in step 205. Afterwards the compilation of the new audit trigger commences in step 106. If no audit trigger exists in step 204, the process goes directly to step 206 to compile and execute a create trigger script.

The process then tests the rule set to determine if record-level information should be audited in step 207. If so, a loop 217 is executed with regards to the record-level information. If not, the process moves ahead to step 211. In loop 217 the process goes to the each operation one by one in step 208. For each potential operation, for example, without limitation, insert, update and delete, the process consults the rule set to determine if that operation should be audited in step 209. If so, the process constructs an insert statement to insert a record into the record-level audit table and record the operation at the record level in step 210. The process then goes back to step 208 to go to the next operation and repeats loop 217 until all record-level operations are accounted for.

Once all record-level operations have been accounted for, loop 217 is exited and the process queries the rule set to determine if column-level information should be included in the audit in step 211. If so, the process retrieves a list of columns for the table specified in the designation in step 212. If not, the process skips forward to step 216. After the list of columns in the designation table is compiled, a loop 218 is entered in which, for each combination of column and operation, the process uses the rule set to determine if that particular column for that particular operation should be audited. Within loop 218 at step 213, the process goes to each combination of column and operation one by one as compiled in step 212. Then in step 214, the process determines if the combination should be performed. At this point the present embodiment we would be looking to see if the rule indicate that we should be recording audit level information for an operation, designation and a specific column. Accordingly, some examples include “update Order Column A” or “insert Order Column A” or “delete Order Column A” If the combination should be performed, in step 215, an insert statement is added to the trigger to record any change to the column value when that particular operation occurs. The process then returns to step 213 to go to the next combination of column and operation.

Once all of the combinations compiled in step 212 are accounted for, loop 218 is exited and the process goes to step 216 to determine if there are any more designations remaining as compiled in step 202. If designations remain, the process goes to step 203 to go to the next designation, and the process repeats until all of the designations are accounted for. If no designations remain, the process ends.

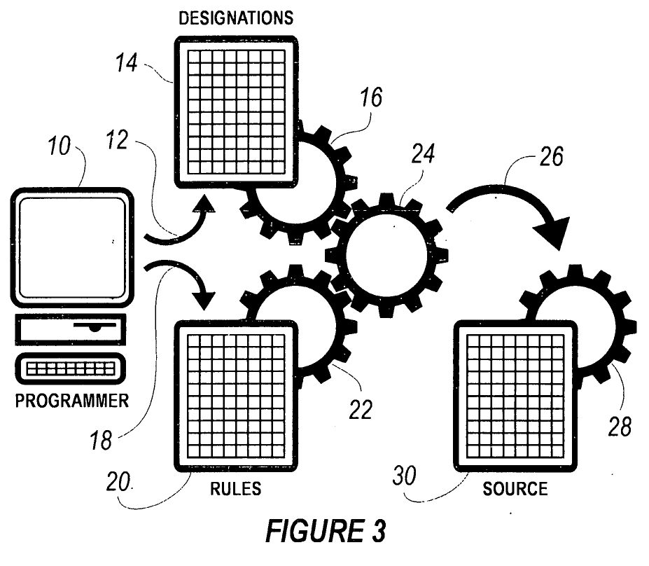

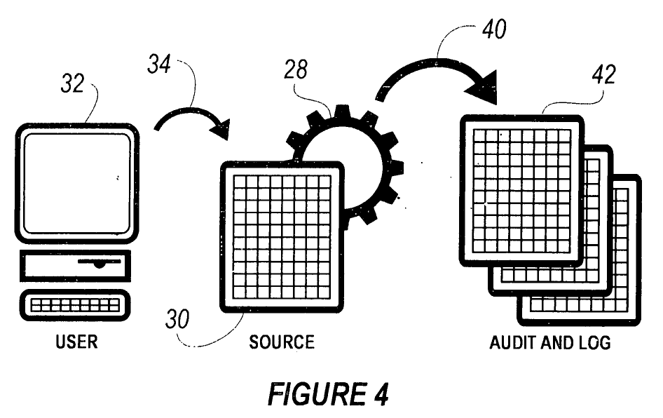

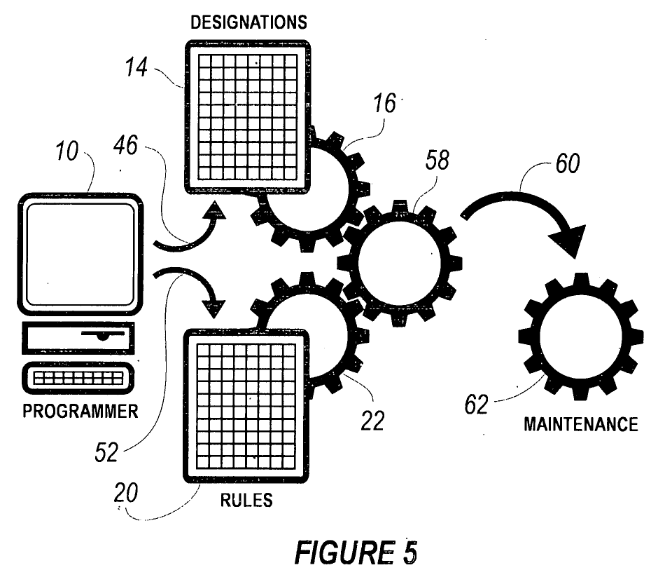

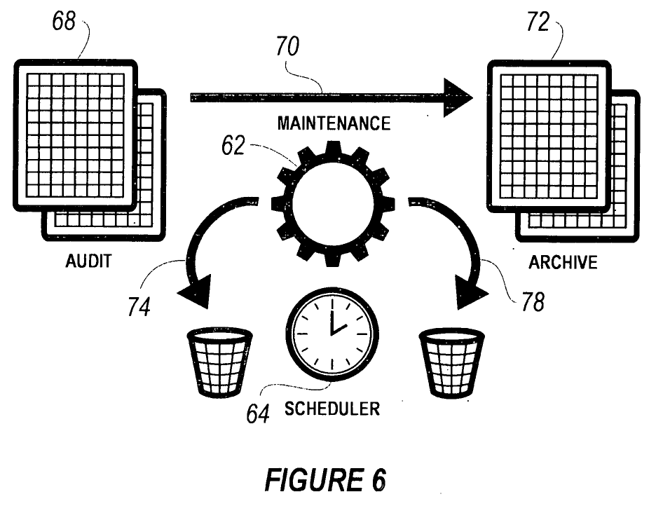

FIGS. 3 through 6 illustrate an exemplary system for automatically building audit triggers on a database, in accordance with an embodiment of the present invention. In figures, there are two informative tables, a designations table and a rules table. The designations table holds the names of data tables and aliases known as the designations of the data tables. The rules table contains rules that are interpreted by the functionality that builds the audit triggers. The rules table provides the programmer with a great deal of flexibility regarding the manner in which the triggers are built. FIG. 3 shows an exemplary process that occurs when a programmer alters information in either the designations table or the rules table and causes one or more audit triggers to be built on the source tables of the audit operation. FIG. 4 shows an exemplary process that occurs when a user alters data in an audited table that contains an audit trigger built by the process shown by way of example in FIG. 3. FIG. 5 shows an exemplary process that occurs when a user alters the information in either the designations table or the rules table and causes a maintenance procedure to be built or rebuilt. FIG. 6 shows an exemplary process that occurs when a maintenance procedure is scheduled that archives audit data, discards audit data or both.

The present embodiment is able to quickly create audit triggers using a method that provides immediate results combined with a maximum level of flexibility. For example, without limitation, to generally maximize flexibility, the system may enable a rule to be applied to all tables specific in the informational tables or to be applied only to a specific table. The present embodiment comprises triggers on informational tables that contain data on which tables should be audited and how audit triggers should be built. The triggers on these informational tables instantly activate when a user enters any information and the altered record is saved to the database. The informational table triggers then automatically build the necessary audit triggers on the tables that should be audited. The present embodiment enables users to implement auditing using a simple, reliable, quickly applied method. While this method can be installed in seconds on a database, the present embodiment is also highly extensible because the informational tables can be expanded indefinitely to address any future requirements.

The present embodiment operates generally as follows. In FIG. 3 when a programmer 10 performs an audit-information data alteration function 12 in a designations table 14, a trigger 16 is invoked and calls a stored procedure 24. Those skilled in the art in light of the present teachings will recognize that stored procedure 24 may be many various different procedures such as, but not limited to, Stored Procedure 24 may be an SQL script or a precompiled run-time module written in any language capable of generating triggers that can read the available audit data and write it into the audit tables. It would operation in a many similar but not limited to FIG. 2. The same process occurs when programmer 10 performs an audit-information data alteration function 18 in a rules table 20 and a trigger 22 is invoked. Stored procedure 24 then performs a build function 26 that builds an audit trigger 28 on a source table 30. Once audit trigger 28 is built, the process shown by way of example in FIG. 4 may occur. When a user 32 performs a data alternation function 34 in source table 30, audit trigger 28 is invoked, and audit trigger 28 records changes 40 that have occurred in audit and log tables 42.

In FIG. 5, when programmer 10 performs a maintenance-information data alteration function 46 in designations table 14, trigger 16 is invoked and calls a stored procedure 58. Examples of stored procedure 58 include, without limitation, Stored Procedure 58 may be an SQL script or a precompiled run-time module written in any language capable of generating a process that can perform the desired maintenance operations. These maintenance operations would include but not be limited to archiving data from the audit tables to the archive audit tables and deleting data from both the audit and audit archive tables. The same process occurs when programmer 10 performs a maintenance-information data alteration function 52 in rules table 20 and trigger 22 is invoked. Stored procedure 58 then performs a building function 60 that builds a maintenance procedure 62.

As shown by way of example in FIG. 6, once maintenance procedure 62 is created, maintenance procedure 62 can be called by a scheduler 64 to perform an archive data function 70 by moving data from audit tables 68 to archive tables 72. Maintenance procedure 62 can also perform a discard data function 74 from audit tables 68 or a discard data function 78 from archive tables 72.

The present embodiment does not require a programmer to manually code statements to perform data auditing or to manually create audit triggers. The preset embodiment also does not require a programmer to manually execute a build procedure to create audit triggers. Furthermore, the present embodiment does not require a programmer to execute a third party application to create audit triggers. The present embodiment does enable a programmer to build and destroy audit triggers using any mechanism that exists to add and delete data from database tables. For instance, without limitation, if a programmer is going to load hundreds of thousands of records using an overnight process and the programmer does not want the data in these records to be audited, the programmer can remove the trigger by altering the data in the informational tables at the beginning of the process. The programmer may then rebuild the triggers at the end of the process by altering the data in the information tables in a second time.

There are many operations that may be used in database auditing implementing embodiments of the present invention. As previously described, by way of example, embodiments of the present invention are able to determine if these operations should be applied to various columns of informational tables when being audited. Table 1 is an exemplary rules table comprising operations that may be used when auditing a database, in accordance with an embodiment of the present invention. Table 1 illustrates the following operations: alias, archive, audit, discard, monitor, and redefine. The alias operation is used to rename three common audit columns and five audit tables. The archive operation indicates the age of the data that is to be moved from the normal audit tables to the archive audit tables. The audit operation is used to indicate what should be written out in the audit data at a record-level, column-level or both. The discard operation indicates the age of the data that is to be deleted from the audit tables. If there is no archive rule in force for the designation, the data is deleted from the normal tables. Otherwise, the data is deleted from the archive tables. If the archive and discard rules are used together, the time indicated in the discard rule should be greater than the time indicated in the archive rule because both rules used the original log date/time of the audit data in their calculations. The monitor operation is used to indicate a column that should be monitored to determine if audit data should be written. Finally, the redefine operation is used to redefine some structure element of the system.

Instead of providing examples of all the rules listed above, Table 1 is presented to give examples only for the “audit” rule because that rule demonstrates the flexibility of the rule scheme. Those skilled in the art will readily recognize how to best implement the foregoing rules based upon the present teachings. Other rules may then be introduce, by, for example, something like . . . “An example of other rules would be: alias, archive, discard, monitor, and redefine . . . ”

| Rule | Designation | Scope | Type | Instruction | Operation | Subject |
|---|---|---|---|---|---|---|
| 1 | All | Record | Audit | Exclude | Insert | [no value |
| | | | | | | needed] |
| 2 | Order | Record | Audit | Include | Update | [no value |
| | | | | | | needed] |
| 3 | All | Column | Audit | Exclude | All | ColumnA |
| 4 | Order | Column | Audit | Include | Delete | ColumnB |

### Table 1 shows four possible audit rules that might be entered into a rules table.

In Rule 1, the keyword “All” is used for the designation indicating that this rule should be applied to all designations. The scope is “Record” which means that this rule is interpreted by the portion of the build procedure that builds the record level portion of the audit trigger. The type is “Audit” which indicates that this rule governs the quantity data that is audited by the trigger. The instruction is “Exclude” which tells the build procedure to exclude the audit data that conforms to the rest of the rule. The operation value is “Insert” which tells the build procedure to exclude record level auditing data on insert operations. In other words, this rule will instruct the build procedure to exclude all insert operations at the record level for all designations (i.e. the resulting audit triggers will not record when records in the source tables are created). Rule 2 instructs the build procedure to construct a trigger for the Orders table that only records audit data at the record level when the operation is an update. In other words, with this rule in place, the resulting audit trigger for the Orders table would only record level audit information when a source record is updated but not when a source record was inserted or deleted. Rule 3 would result in every audit trigger being rebuilt such that every designation will contain an audit trigger that ignores changes to any column in the source tables that is named “ColumnA”. This will occur because the keyword “All” has been used in the Operation value as opposed to the normal “Insert”, “Update” or “Delete”. Rule 4 indicates to the build procedure that the audit trigger for the Orders table should only record column level audit data for ColumnB when a when an Orders record is deleted

Those skilled in the art, in light of the present teachings, will recognize that various different operations may be used when auditing a database while implementing an embodiment of the present invention such as, but not limited to, logging of trigger times, formatting of column level data in the audit tables, appending additional information to the audit information that may be derived from function calls or system variables]. Similarly, the same function may be performed by operations with various different names. For example, without limitation, data may be removed from the database by an operation named discard or delete.

Embodiments of the present invention benefit any programmer who desires to audit data in any application that he or she is creating. These embodiments are especially useful to small programming houses or single programmers who are building web applications because these programmers typically do not desire to spend the cost required to buy an application to build audit triggers. These programmers typically code audit triggers by hand or simply implement application without any data auditing. These programmers generally regret not allowing for data auditing particularly when the programmers are unable to figure out who is changing the data and causing problems in the data application when problems occur. Embodiments of the present invention may also be useful for programmers who are debugging complex stored procedures because these embodiments enable the programmer to enable auditing on affected tables within seconds, run the stored procedures and then see exactly what data was changed and when. This enables programmers to debug problem arcas without having to step through procedures one statement at a time.

Since embodiments of the present invention are designed to be flexible and extensible, there are many potential embodiments. In a relatively simple embodiment, the system comprises a single informational table and this table has a single column. This informational table holds table names and a trigger to build audit triggers on each of the tables listed. Each of these triggers copies the data being changed from the source table to an audit table. The build trigger checks to see if an audit trigger exists on the table specified by the table name in the informational table. If the audit trigger exists, the build trigger deletes the audit trigger. The build trigger also checks to see if an audit table exists with the same columns as the table being audited. If the audit table does not exist, the build trigger retrieves a list of columns for the table from the database system tables and compiles a create table command and executes this command. The build trigger creates an audit trigger for the table that records any changes in data in the audit table each time the source table data is changed. Then, the system extracts a list of columns for the source table and builds a trigger that moves all of the columns of all of the changed records from the source table to the destination table.

Those skilled in the art, in light of the present teachings, will recognize that various embodiments may employ various different steps and functions. Another relatively simple embodiment of the present invention builds and executes audit triggers by the following method. A programmer or database administrator runs a script on the database to build all of the necessary components. The programmer or database administrator then places the names of all of the tables in the database that should be audited for changes in an informational table. This action initiates the processes described previously with respect to the system shown by way of example in FIGS. 3 through 6 and auditing of the table immediately commences. When an additional table needs to be audited, the programmer or database administrator adds the table name to the designation table and the system builds an audit trigger for that table as well. Then the programmer or database administrator removes a table name from the designations table, and the audit trigger is removed.

In an alternate embodiment, the same build trigger may build audit triggers that use a common audit data table. This common audit data table stores all of the data changes of all of the tables that are being audited and includes, without limitation, the following columns: the designation for the table, the record identifier, the name of the column, the old value of the column, the new value of the column, the name of the user who altered the data, and the date and time of the alteration.

Other alternate embodiments include, without limitation, one or more additional informational tables and enable the programmer the ability to selectively perform functions such as, but not limited to, the following. The programmer may choose and exclude the columns being audited on a give table. The programmer may implement auditing across multiple databases located on the same server or on different servers. The programmer may control the amount of data that is audited both at a record-level and at a column-level. Some embodiments may enable the programmer to change the names of the tables such as, but not limited to, audit, log and archive tables and append additional information to tables such as, but not limited to, audit and archive tables. Some embodiments may enable the programmer to log trigger process times, stipulate the amount of time to retain audit data before discarding this data, stipulate the amount of time to retain audit data before archiving, and stipulate the amount of time to retain archive data before discarding. The list of functions that may be performed in various embodiments of the present invention is open-ended.

An alternate embodiment of the present invention comprises one or more additional informational tables to dictate the manner in which the audit triggers should be built. In this embodiment, all audit data is written into a common set of audit tables. This embodiment also has a record-level audit table that includes, without limitation, creation, modification and deletion times for records. The present embodiment also comprises a column-level table that has one record for every column in every table that is audited. For instance, without limitation, if an order record contained five columns of data, each column is listed separately in the column-level audit table with its designation, identifier, column name, old value, new value, username, and date/time stamp.

In this embodiment there are triggers on all of the informational tables. Each of these triggers invokes the same store procedure to build the audit triggers. In the present embodiment, the following steps are performed for each designation that has changed. First it is determined if the record-level and column-level tables have been renamed by a rule in the informational tables. If so, a note is made of the new names so that when the insert statements are constructed to move data from the source table to the record-level and column-level tables are constructed, the statements do not error off. Then, the database name, owner and table name of the designation are determined by pulling the information from the designations table. Then the audit trigger is deleted from the designations table if an audit trigger exists.

If the designation record for the table indicates that either record-level or column-level auditing is enabled, the system attempts to build the audit trigger. It is then determined if record-level information should be written for this designation. If so, the system loops through all of the types of data manipulation that can occur, such as, but not limited to, insert, update, and delete, and determines which of these should be included in the trigger according to the current rule set. The system then checks to see if column-level information should be written for this designation. If so, the system loops through all of the combinations of data manipulation and column names and includes each combination that should be included in the trigger according to the current rule set.

Another alternate embodiment comprises an informational trigger and a scheduled procedure that can wake up at periodic intervals to determine if audit triggers need to be rebuilt.

Some distinguishing characteristics of embodiments of the present invention versus other methods are as follows. In current methods, the use of creation and modification columns only provides audit data on the timing of the insert or update operation and not the actual data that was involved. In addition the use of a modified by and/or a modification date column only records the last time the data was modified, not the entire chain of modifications. Embodiments of the present invention not only provide the timing information of the data audit, these embodiments also provide the actual data that was modified. These embodiments also enable programmers to view the entire chain of modifications. While manually coded triggers, as used by some current methods, can certainly record every modification to the data, any changes to the number and/or type of columns in the table must be manually included, raising the possibility of error and neglect. The automation of triggers in embodiments of the present invention generally eliminates these types of errors.

The use of an external application to generate audit triggers can reduce the potential for error and provides flexibility in designing the trigger. But, since the trigger is being designed by an entity that exists outside the environment of the database, the application's potential for external automation is limited. For example, without limitation, it is relatively difficult to launch an application from within a stored procedure and remotely instruct it to alter a given audit trigger according to some preconceived scheme. Internal triggers within the database as used in embodiments of the present invention generally do not pose this problem.

While transaction log viewers used in current methods never need updating due to changes in the number and type of columns in a table, transaction log viewers are merely reporting on data that was created solely for backup recovery and are therefore limited in their ability to provide selective auditing of data changes within a specific set of criteria. For instance, without limitation, a give business might only desire to audit and retain performance data on employees who are on probation. In other words, at the moment that the performance record is created, the auditing functionality must be able to determine if the employee connected to the performance record is on probation. Transaction logs are not concerned with these kinds of connections. Transaction logs merely record changes to data and therefore the transaction log viewer is limited in scope. Embodiments of the present invention are relatively less limited in scope and may be able to selectively perform auditing functions.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like.

It will be further apparent to those skilled in the art that at least a portion of the novel method steps and/or system components of the present invention may be practiced and/or located in location(s) possible outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing novel means for and/or steps described that the applications designer will selectively decide, depending upon the practical considerations of the particular implementation, to carry out and/or locate within the jurisdiction of the USA. For any claims construction of the following claims that are construed under 35 USC § 112 (6) it is intended that the corresponding means for and/or steps for carrying out the claimed function also include those embodiments, and equivalents, as contemplated above that implement at least some novel aspects and objects of the present invention in the jurisdiction of the USA. Hence, it will be obvious to those in the art that some aspects of the present invention may be performed and/or located outside of the jurisdiction of the USA while the remaining method steps and/or system components of the foregoing embodiments are typically required to be located/performed in the US for practical considerations.

Having fully described at least one embodiment of the present invention, other equivalent or alternative means for implementing a system and method for automatically building audit triggers on a database according to the present invention will be apparent to those skilled in the art. For example, without limitation, the number of tables such as, but not limited to, informational tables and audit tables, may vary depending on the application. Also, depending on the rules set of the embodiment, auditing systems may perform a wide variety of operations. The invention has been described above by way of illustration, and the specific embodiments disclosed are not intended to limit the invention to the particular forms disclosed. The invention is thus to cover all modifications, equivalents, and alternatives falling within the spirit and scope of the following claims.

What is claimed is:

1. A method for building audit triggers on database tables, the method comprising the Steps of:
compiling at least one informational table comprising names of one or more source tables to be audited;
constructing at least one build trigger comprising sufficient functionality for building audit triggers on said source tables; and
installing said informational table and build trigger in a database environment in which said build trigger instructs a database engine to build audit triggers on said source tables.

2. The method as recited in claim 1, further comprising constructing additional functionality for generating audit tables for receiving data from the audit triggers.

3. The method as recited in claim 1, further comprising constructing additional functionality to build, rebuild or delete audit triggers when data in said informational table is changed.

4. The method as recited in claim 1, further comprising providing a rules table comprising rules for interpretation by said functionality in building the audit triggers.

5. The method as recited in claim 4, further comprising constructing additional functionality to build, rebuild or delete audit triggers when data in said rules table is changed.

6. The method as recited in claim 1, further comprising constructing additional functionality for scheduling building of the audit triggers.

7. The method as recited in claim 1, further comprising constructing further functionality for scheduling maintenance procedures for the data in said audit tables to govern when data is archived and/or discarded.

8. A method for building audit triggers on database tables, the method comprising:
steps for providing at least one informational table;
steps for constructing at least one build trigger; and
steps for installing said informational table and said build trigger in a database environment in which said build trigger instructs a database engine to construct the audit triggers.

9. The method as recited in claim 8, further comprising steps for providing a rules table for said build trigger.

10. The method as recited in claim 9, further comprising steps for providing a functionality to build, rebuild or delete audit triggers when data in said rules table is changed.

11. The method as recited in claim 8, further comprising steps for providing a functionality to build, rebuild or delete audit triggers when data in said informational table is changed.

12. The method as recited in claim 8, further comprising steps for generating one or more audit tables.

13. The method as recited in claim 8, further comprising steps for providing functionality for scheduling building of the audit triggers.

14. The method as recited in claim 8, further comprising steps for providing maintenance procedures.

15. A system for building and using audit triggers on database tables, the system comprising:
means for constructing at least one informational table;
means for constructing a build trigger;
means for installing said informational table and said build trigger in a database environment where audit triggers are constructed; and
means for accessing the database tables and activating audit triggers.

16. The system as recited in claim 15, further comprising means for providing a rules table.

17. The system as recited in claim 15, further comprising means for generating one or more audit tables.

18. The system as recited in claim 15, further comprising means for providing maintenance procedures.

19. The system as recited in claim 15, further comprising means to build, rebuild or delete audit triggers when data in said informational table is changed.

20. The system as recited in claim 16, further comprising means to build, rebuild or delete audit triggers when data in said rules table is changed.
